(19) United States
(12) Patent Application Publication
(10) Pub. No.: US 2013/0330991 A1
(43) Pub. Date: Dec. 12, 2013

(54) COMPOSITE MATERIAL AND METHOD FOR PREPARING THE SAME

(71) Applicants: Shaupoh Wang, Taichung City (TW); Yung-Chih Chen, Taichung City (TW); Ying-Jen Chu, Taichung City (TW); Kuo Ysun Yang, Taichung City (TW)

(72) Inventors: Shaupoh Wang, Taichung City (TW); Yung-Chih Chen, Taichung City (TW); Ying-Jen Chu, Taichung City (TW); Kuo Ysun Yang, Taichung City (TW)

(73) Assignee: Taiwan Green Point Enterprises Co., LTD

(21) Appl. No.: 14/001,101

(22) PCT Filed: Feb. 22, 2012
(86) PCT No.: PCT/US12/26142

§ 371 Date: Aug. 22, 2013

Related U.S. Application Data
(60) Provisional application No. 61/445,563, filed on Feb. 23, 2011.

(51) Int. Cl. B29C 70/50

(52) U.S. Cl. CPC B29C 70/506
USPC 442/67; 156/306.3; 442/59; 442/65

(57) ABSTRACT

A composite material includes a porous substrate covered by thermoplastic foil. The porous substrate has a top side, a bottom side, and a plurality of gaps connecting the top side with the bottom side. The thermoplastic foil covers the top side and the bottom side, and fills the gaps. A method for preparing the composite material includes the steps of preparing a porous substrate having a top side, a bottom side, and a plurality of gaps connecting the top side with the bottom side. A top foil is placed on the top side and a bottom foil is placed on the bottom side, and a force is then applied to the top foil at a predetermined temperature, thereby filling the gaps with the top foil or the bottom foil.

### CROSS REFERENCE TO RELATED APPLICATIONS

This application claims the benefit of Provisional Application Ser. No. 61/445,563 entitled “A method of manufacturing a composite material,” filed Feb. 23, 2011, which is incorporated herein by reference in its entirety.

### BACKGROUND

The present invention relates to the field of composite material fabrication, and more particularly, to a composite material having a porous substrate, such as woven fiber mat or fabric, covered by thermoplastic and a method for preparing the same.

Reinforced composites made with thermoset materials and fiber mat or fiber fabric have been widely applied in the aerospace, automotive, industrial/chemical, and sporting goods industries. In the impregnation process, liquid thermoset resins are deposited onto the fiber mat and cured. Several layer can be combined into one thicker layer or the thickness of the thermoset can be increased by repeating the impregnation process. Thermoset composites made by the “imprepreg” method require lengthy cure times with alternating pressures to control the flow of the resin as it thickens to prevent bubbles in the matrix. However, thermosetting resins are not able to be recycled because they can not be formed again after curing.

Impregnation can also be applied to making thermal plastic composite by dissolving thermal plastic in solvent. However, the plastic composite is often degraded when it is dissolved in solvent and solvent is environmentally unfriendly. In addition, air can be trapped in the fabric easily and become defects. Another disadvantage of impregnated composite is that its thickness is often uneven and require additional pressing and polishing processes.

### BRIEF SUMMARY

One aspect of the present invention discloses a composite material including a porous substrate, such as woven fiber-fabric or fiber-mat, having a top side, a bottom side, and a plurality of gaps connecting the top side with the bottom side; and a thermoplastic covering either or both the top side and the bottom side and filling the gaps. If an optimal structure is required, the thermal plastic on one side can be selected to have better hardness against scratch and the other thermal plastic can be selected to have higher toughness against fracture.

Another aspect of the present invention discloses a method for preparing a composite material comprising the steps of preparing a porous substrate, such as woven fiber-fabric or fiber-mat, having a top side, a bottom side, and a plurality of gaps connecting the top side with the bottom side; placing a thermal-plastic foil on either or both the top side or/and on the bottom side; and applying a force to the top foil at a predetermined temperature, thereby filling the said gaps of the fiber fabric/mat with the thermal plastic.

Since thermosetting materials can not be formed after it is cured, the shaping process of the conventional thermoset composite material must be performed at the same time as the curing process (preparation process) of the thermoset resin of the thermoset composite material. In contrast, the shaping process of the thermoplastic composite material in accordance with embodiments of the invention can be performed after the preparation of the thermoplastic composite material, without being limited to the preparation process.

Furthermore, the conventional thermoset composite material cannot be reshaped after the shaping process (curing process); in contrast, the molded plastic article from the thermoplastic composite material can be further reshaped into the plastic article in accordance with embodiments of the invention.

Net shape plastic features on the thermal plastic composite can be added by putting the thermal-plastic-composite component inside a mold and inject molten plastic that bond directly with the thermal plastic on the surface of the composite component. For thermoset composite, an adhesive would have to be pre-applied on the thermoset surface prior to the insert molding.

In addition, as the molded plastic article is discarded, the molded plastic article can be recycled. For example, the discarded plastic article can be cut into pellets to be used as molding material in accordance with embodiments of the invention. In contrast, the conventional thermoset composite material cannot be recycled.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1 is a top view of a porous substrate in accordance with embodiments of the invention.

FIG. 2 is a cross-sectional view of the porous substrate along line 1-1 in FIG. 1 in accordance with one embodiment of the invention.

FIG. 3 is a close-up view of column lines shown in FIG. 2 in accordance with one embodiment of the invention.

FIGS. 4 and 5 are cross-sectional views depicting the preparation of the composite material in accordance with embodiments of the invention.

FIG. 6 illustrates an apparatus for preparing the composite material in accordance with embodiments of the invention.

FIGS. 7 and 8 illustrate a molding apparatus 200 for shaping the thermoplastic composite material 20 in accordance with embodiments of the invention.

FIGS. 9 and 10 illustrate a molding apparatus 300 for reshaping the plastic article 20A in accordance with embodiments of the invention.

### DETAILED DESCRIPTION

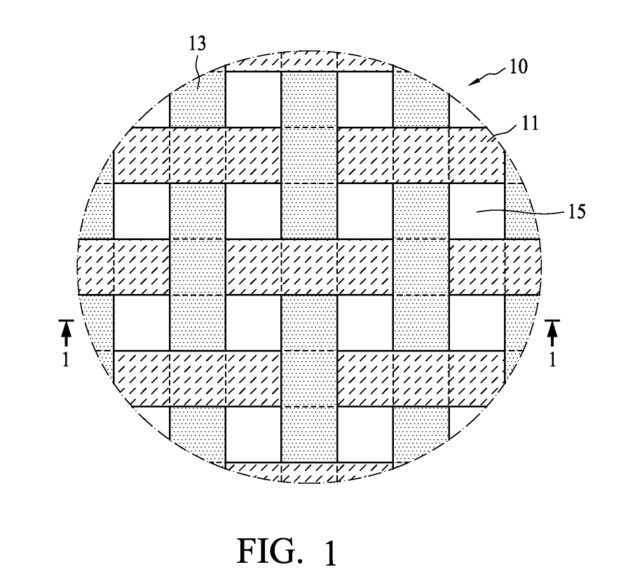

FIG. 1 is a top view of a porous substrate 10 in accordance with embodiments of the invention. In one embodiment of the invention, the porous substrate 10 comprises a plurality of column lines 13 and a plurality of row lines 11 interlaced with the column lines 13, with a plurality of gaps 15 between the row lines 11 and the column lines 13. In one embodiment of the invention, the porous substrate 10 can be a fabric. It should be noted that, in addition to a fabric, the porous substrate 10 can be formed of any suitable material with gaps penetrating through the substrate. It should be also noted that the porous substrate 10 can be formed of any suitable pattern in addition to the one shown in FIG. 1.

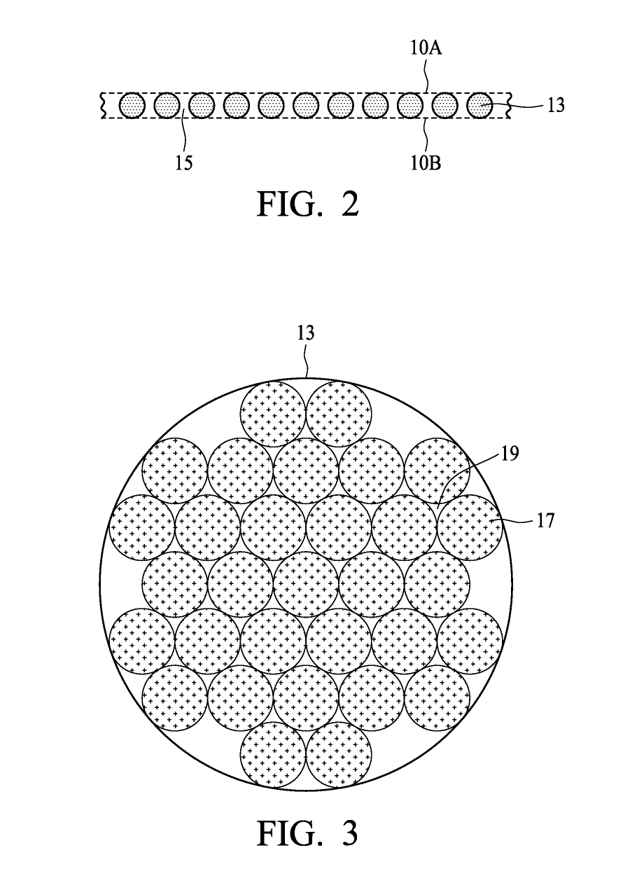

FIG. 2 is a cross-sectional view of the porous substrate 10 along line 1-1 in FIG. 1 in accordance with one embodiment of the invention. In one embodiment of the invention, the porous substrate 10 has a top side 10A and a bottom side 10B, and the gaps 15 between the column lines 13 connect the top side 10A with the bottom side 10B. It should be noted that the column lines 13 can be any shape in addition to the circle shown in FIG. 2, and the size of the column lines 13 can be different or can be the same size as shown in FIG. 2. Similarly, it should be noted that the row lines 11 can be any shape in addition to the circle shown in FIG. 2, and the size of the row lines 11 can be different or can be the same size as shown in FIG. 2.

FIG. 3 is a close-up view of the column lines 13 shown in FIG. 2 in accordance with one embodiment of the invention. In one embodiment of the invention, each column line 13 comprises a plurality of fibers 17 with gaps 19. It should be noted that the column line 13 may comprise different type of fibers or may comprise the same type of fiber as shown in FIG. 3, and the size of the fibers can be different or can be the same size as shown in FIG. 3. Similarly, each row line 11 comprises a plurality of fibers. It should be noted that the row lines 11 may comprise different type of fibers or may comprise the same type of fiber as shown in FIG. 3, and the size of the fibers in the row lines 11 can be different or can be the same size as shown in FIG. 3. In one embodiment of the invention, the column line 13 and the row line 11 are formed of the same fiber. In another embodiment of the invention, the column lines 13 and the row lines 11 can be formed of different fibers.

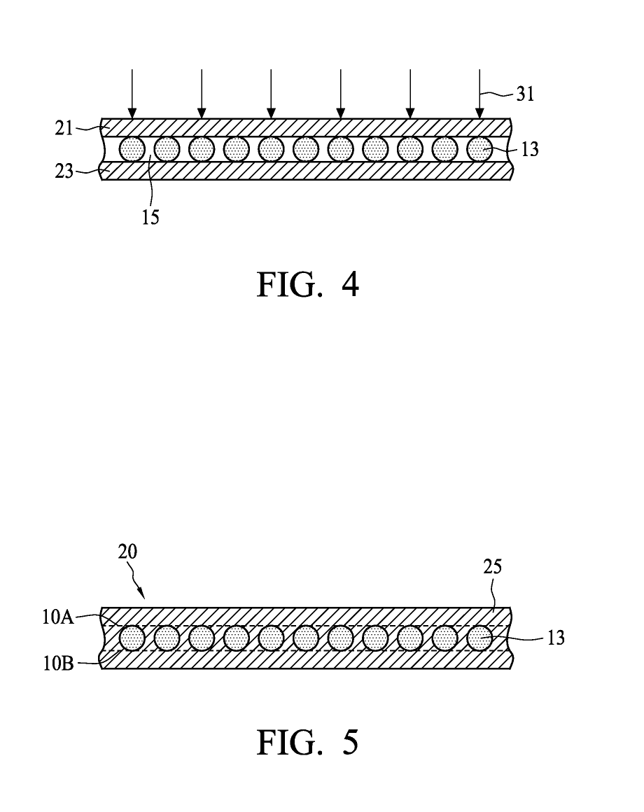

FIGS. 4 and 5 are cross-sectional views depicting the preparation of the composite material 20 in accordance with embodiments of the invention. In one embodiment of the invention, a top foil 21 is placed on the top side 10A and a bottom foil 23 is placed on the bottom side 10B of the porous substrate 10. Subsequently, a force 31 is applied to the top foil 21 at a predetermined temperature, thereby filling the gaps 15 in the porous substrate 10 with the top foil 21 or the bottom foil 23. In one embodiment of the invention, the top foil 21 and the bottom foil 23 are thermoplastic foils formed of polycarbonate (PC), acrylonitrile butadiene styrene (ABS), polymethylmethacrylate (PMMA), polyamide (PA), or the combination thereof.

It should be noted that the top foil 21 and the bottom foil 23 are formed of the same thermoplastic resin. In another embodiment of the invention, the top foil 21 and the bottom foil 23 can be formed of a different thermoplastic resin; for example, PMMA can be used on one side of the porous substrate 10 for better scratch resistance and PC can be used on the other side of the porous substrate 10 for better toughness. It should be noted that the top foil 21 and the bottom foil 23 may have different sizes or may have the same size as shown in FIGS. 4 and 5.

In one embodiment of the invention, the predetermined temperature is above a soften temperature of the thermoplastic resin forming the top foil 21; for example, the soften temperature can be the glass transition temperature of the thermoplastic resin. In one embodiment of the invention, the applied force 23 pushes the top foil 21 and/or the bottom foil 23 into the gaps 15 between the column lines 13 and the row lines 11, thereby forming a thermoplastic foil 25. In one embodiment of the invention, the applied force 23 also pushes the top foil 21 and/or the bottom foil 23 into the gaps 19 among the fibers 17. In one embodiment of the invention, the thermoplastic foil 25 covers the top side 10A and the bottom side 10B of the porous substrate 10.

In one embodiment of the invention, the thickness of the thermoplastic composite can be increased by laminating additional thermoplastic foil and/or additional porous substrate on the top side and/or the bottom side, wherein the additional thermoplastic foil can be formed of the same plastic resin or different plastic resins. It should be noted that the thickness of the thermoplastic composite can also be increased by laminating two or more composite material 20, wherein the composite material 20 can be formed of the same plastic resin or different plastic resins.

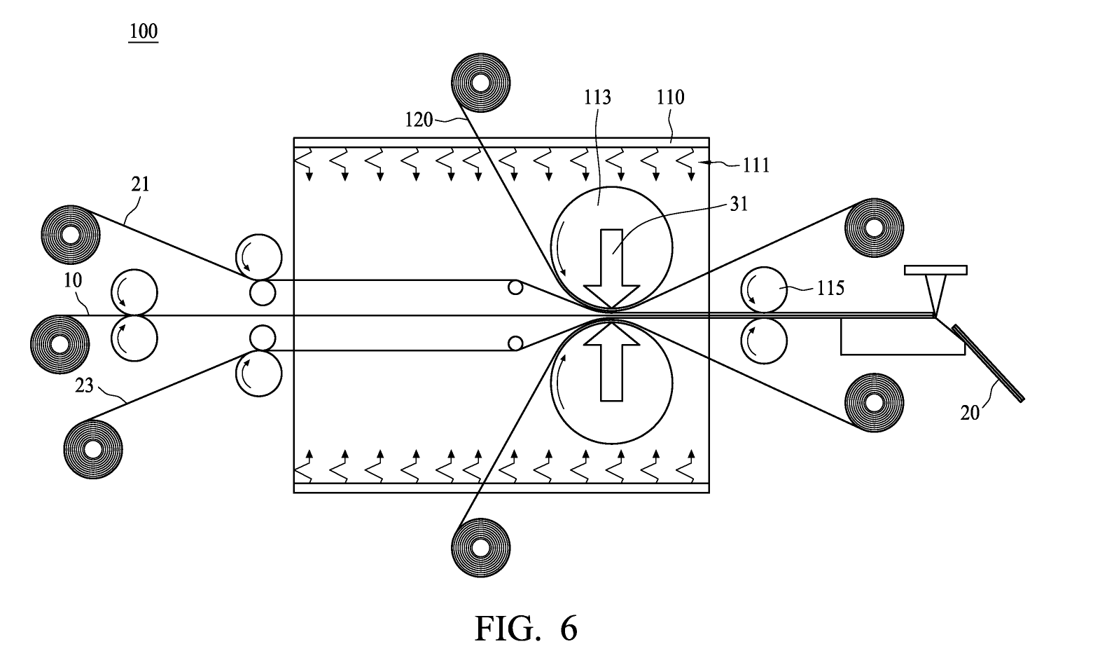

FIG. 6 illustrates an apparatus 100 for preparing the composite material 20 in accordance with embodiments of the invention. In one embodiment of the invention, the apparatus 100 comprises a heating region 110 with heaters 111 configured to heat the incoming top foil 21, the porous substrate 10 and the bottom foil 23 to the predetermined temperature (the soften temperature). In the heating region 110, thermal rollers 113 apply the force 31 to the top foil 21 and the bottom foil 23 via an intervening sheet 120, thereby filling the gaps 15 of the porous substrate 10 with the thermoplastic resin of the top foil 21 or the bottom foil 23.

In one embodiment of the invention, the intervening sheet 120 has a soften temperature higher than the predetermined temperature (the soften temperature), and the intervening sheet 120 does not soften in the heating region 110 such that the intervening sheet 120 can prevent the top foil 21 and the bottom foil 23 from adhering to the thermal rollers 113. In one embodiment of the invention, the intervening sheet 120 comprises polyimide (PI).

After passing through the thermal region 110, the laminate of the top foil 21, the porous substrate 10 and the bottom foil 23 is cooled to a temperature below the predetermined temperature (the soften temperature). In one embodiment of the invention, the cooling step is performed by cooling rollers 115. It should be noted that other cooling means can be used to cool the laminate in addition to the cooling rollers 115 as shown in FIGS. 4 and 5. Subsequently, the laminate is cut into pieces of composite material 20 of desired size, which can be used in a molding process to form a desired shape.

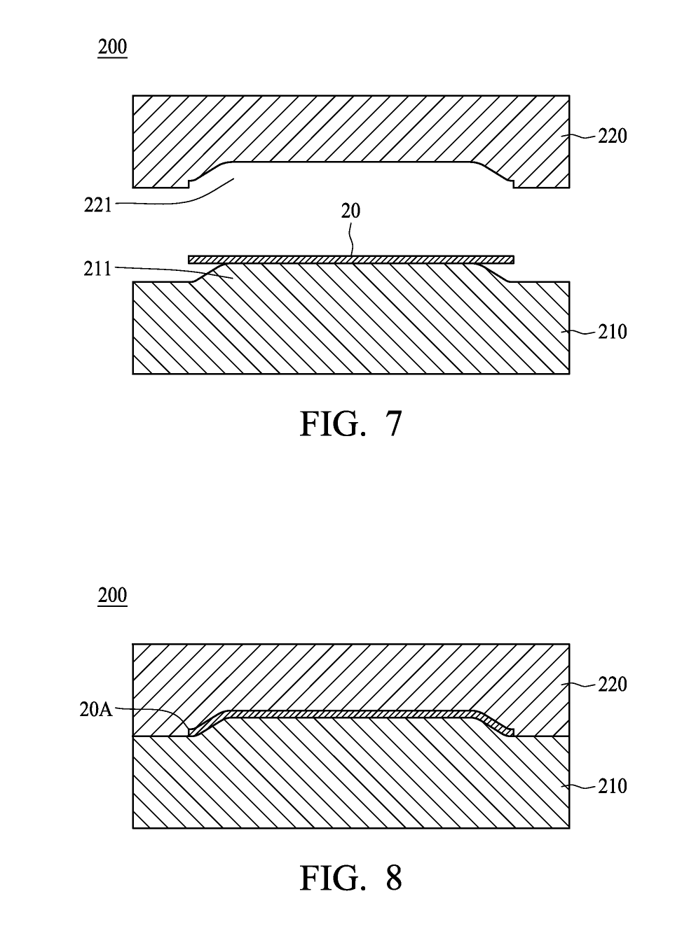

FIGS. 7 and 8 illustrate a molding apparatus 200 for shaping the thermoplastic composite material 20 in accordance with embodiments of the invention. In one embodiment of the invention, the thermoplastic composite material 20 is placed on a bottom mold 210 having a protrusion 211 at a temperature higher than the predetermined temperature (the soften temperature) of the thermoplastic resin of the composite material 20. Subsequently, the composite material 20 is compressed by a top mold 220 having a depression 221 at a temperature higher than the predetermined temperature (the soften temperature) of the thermoplastic resin of the composite material 20, thereby shaping the composite material 20 into a plastic article 20A, which can be the cover of an electronic device.

The shaping process of the conventional thermoset composite material must be performed at the same time as the curing process (preparation process) of the thermoset resin of the thermoset composite material. In contrast, the shaping process of the thermoplastic composite material 20 in accordance with embodiments of the invention can be performed after the preparation of the thermoplastic composite material 20, without being limited to the preparation process.

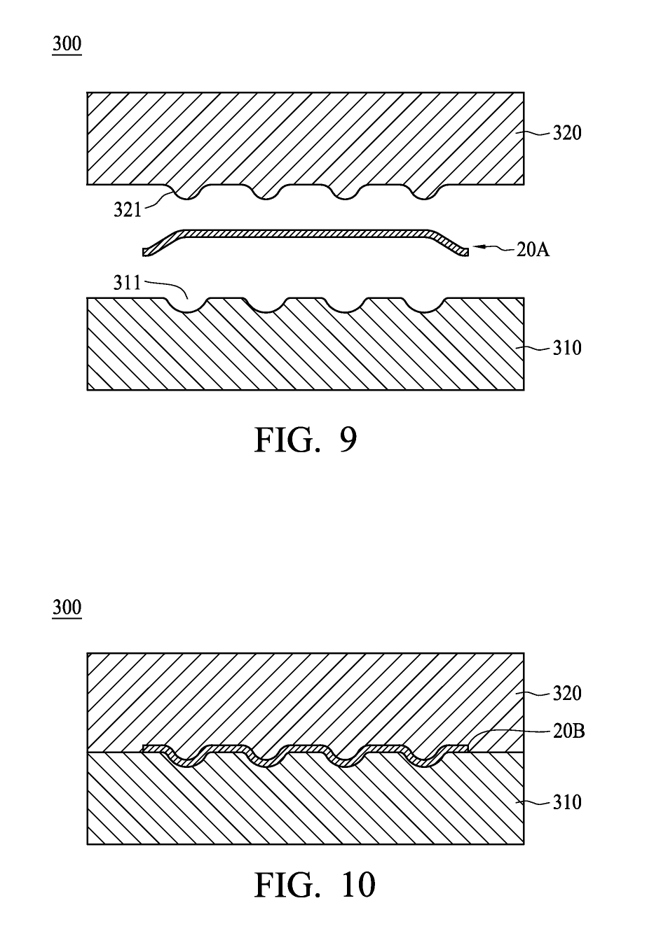

FIGS. 9 and 10 illustrate a molding apparatus 300 for reshaping the plastic article 20A in accordance with embodiments of the invention. In one embodiment of the invention, the thermoplastic plastic article 20A is placed on a bottom mold 310 having a plurality of depressions 311 at a temperature higher than the predetermined temperature (the soften temperature) of the thermoplastic resin of the thermoplastic plastic article 20A. Subsequently, the thermoplastic plastic article 20A is compressed by a top mold 320 having a plurality of protrusions 321 at a temperature higher than the predetermined temperature (the soften temperature) of the thermoplastic resin of the composite material 20, thereby reshaping the thermoplastic plastic article 20A into a plastic article 20B, which can be the cover of an electronic device.

The conventional thermoset composite material cannot be reshaped after the shaping process (curing process); in contrast, the molded plastic article 20A from the thermoplastic composite material 20 can be further reshaped into the plastic article 20B.

In addition, as the molded plastic article 20A is discarded, the molded plastic article 20A can be recycled. For example, the discarded plastic article 20A can be cut into pellets to be used as molding material. In contrast, the conventional thermoset composite material cannot be recycled.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A composite material, comprising:
a porous substrate having a top side, a bottom side, and a plurality of gaps connecting the top side with the bottom side; and
a thermoplastic covering the top side and the bottom side and filling the gaps.

2. The composite material of claim 1, wherein the porous substrate comprises a fabric.

3. The composite material of claim 1, wherein the porous substrate comprises a plurality of column lines and a plurality of row lines interlaced with the column lines.

4. The composite material of claim 3, wherein each column line comprises a plurality of fibers.

5. The composite material of claim 4, wherein each row line comprises a plurality of fibers.

6. The composite material of claim 4, wherein the thermoplastic foil encapsulates the fibers.

7. The composite material of claim 3, wherein the column lines and the row lines are formed of the same fiber.

8. The composite material of claim 3, wherein the column lines and the row lines are formed of different fibers.

9. The composite material of claim 3, wherein the thermoplastic foil fills gaps between the fibers.

10. The composite material of claim 1, wherein the thermoplastic foil comprises PC, ABS, PMMA, PA, or the combination thereof.

11. A method for preparing a composite material, comprising the steps of:
preparing a porous substrate having a top side, a bottom side, and a plurality of gaps connecting the top side with the bottom side;
placing a top foil on the top side and a bottom foil on the bottom side; and
applying a force to the top foil at a predetermined temperature, thereby filling the gaps with the top foil and/or the bottom foil.

12. The method for preparing a composite material of claim 11, wherein the step of applying a force is performed by a roller at the predetermined temperature.

13. The method for preparing a composite material of claim 11, wherein the predetermined temperature is above a soften temperature of the top foil.

14. The method for preparing a composite material of claim 11, wherein the force is applied to the top foil via an intervening sheet.

15. The method for preparing a composite material of claim 14, wherein the top foil has a first soften temperature, and the intervening sheet has a second soften temperature higher than the first soften temperature.

16. The method for preparing a composite material of claim 11, further comprising a step of cooling the composite material.

17. The method for preparing a composite material of claim 16, wherein the cooling step is performed by a roller.

18. The method for preparing a composite material of claim 17, wherein the roller is at a temperature lower than the predetermined temperature.

19. The method for preparing a composite material of claim 11, wherein the top foil is a thermoplastic foil.

20. The method for preparing a composite material of claim 19, wherein the thermoplastic foil comprises PC, ABS, PMMA, PA, or the combination thereof.

21. The method for preparing a composite material of claim 11, further comprising a step of shaping the composite material into a plastic article.

22. The method for preparing a composite material of claim 21, further comprising a step of reshaping the plastic article.
